(19) United States
(12) Patent Application Publication
(10) Pub. No.: US 2009/0011260 A1
(43) Pub. Date: Jan. 8, 2009

(54) Heat-Insulating Protective Layer for a Component Located Within the Hot Gas Zone of a Gas Turbine

(75) Inventors: Sharad Chandra, Oberhausen (DE); Norbert Czech, Dorsten (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN Turbo AG, Oberhausen (DE)

(21) Appl. No.: 12/084,726

(22) PCT Filed: Nov. 7, 2006
(86) PCT No.: PCT/EP2006/010655

§ 371 Date: Jul. 3, 2008

(30) Foreign Application Priority Data
Nov. 8, 2005 (DE) 10 2005 053 531.3

(51) Int. Cl. B32B 15/00; C23C 8/06

(52) U.S. Cl. 428/457; 148/240

(57) ABSTRACT

Disclosed is a heat-insulating protective layer for a component located within the hot gas zone of a gas turbine. Said protective layer is composed of an adhesive layer, a diffusion layer, and a ceramic layer which is applied to the high temperature-resistant basic metal of the component. The adhesive layer comprises a metal alloy [MCrAlY (M=Ni, Co)] containing Ni, Co, Cr, Al, Y, the diffusion layer is produced by calorizing the adhesive layer, and the ceramic layer is composed of ZrO2 which is partially stabilized by means of yttrium oxide. One or several chemical metal elements that have a large atomic diameter and are selected among the group comprising Re, W, Si, Hf, and/or Ta are alloyed to the material of the adhesive layer. The adhesive layer has the following chemical composition after being applied: Co 15 to 30 percent, Cr 15 to 25 percent, Al 6 to 13 percent, Y 0.2 to 0.7 percent, Re up to 5 percent, W up to 5 percent, Si up to 3 percent, Hf up to 3 percent, Ta up to 5 percent, the remainder being composed of Ni.

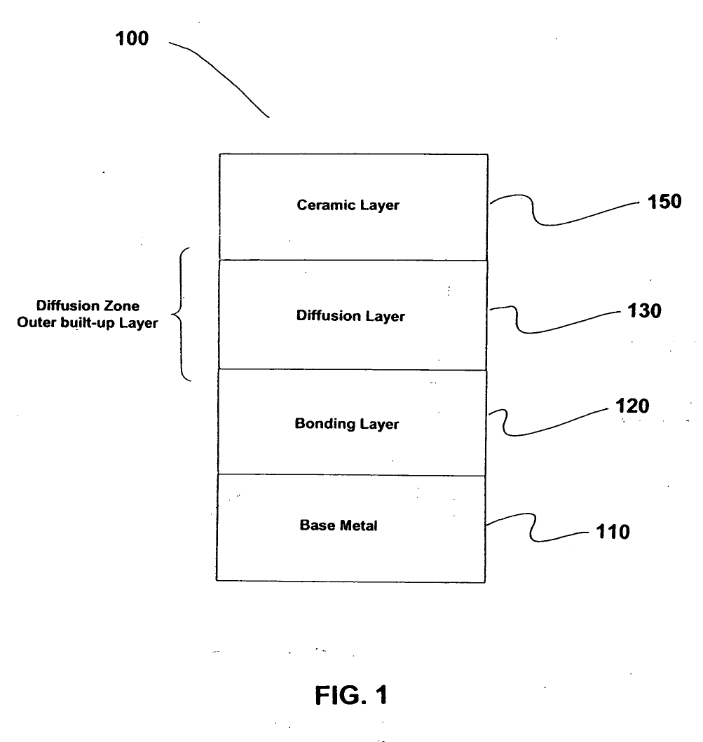

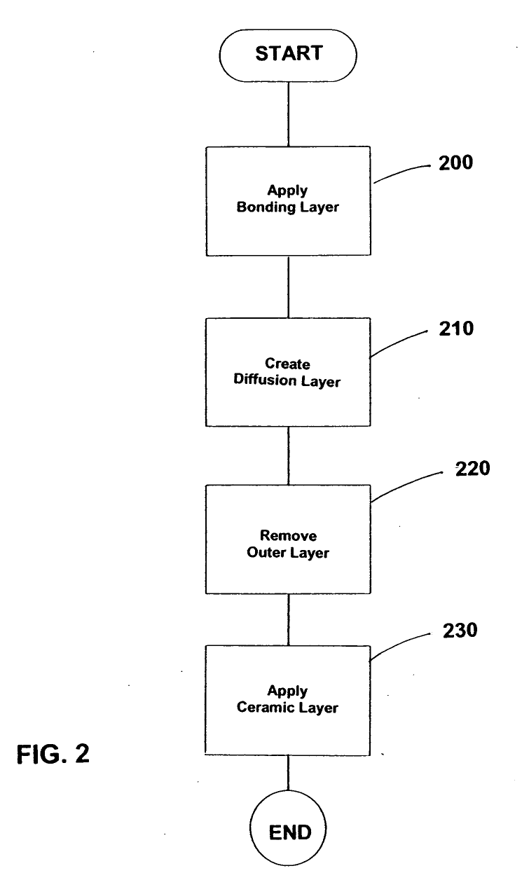

The invention pertains to a heat-insulating protective layer for a component within the hot-gas section of a gas turbine with the features of the introductory clause of Claim 1.

In modern gas turbines, almost all of the surfaces in the hot-gas section are provided with coatings. Exceptions in many cases are still the turbine blades in the rear of an array. The heat-insulating layers serve to lower the material temperature of the cooled components. As a result, their service life can be extended, cooling air can be reduced, or the gas turbine can be operated at higher inlet temperatures. Heat-insulating layer systems in gas turbines always consist of a metallic bonding layer diffusion bonded to the base material, on top of which a ceramic layer with poor thermal conductivity is applied, which represents the actual barrier against the heat flow and which protects the base metal of the component against high-temperature corrosion and high-temperature erosion.

As the ceramic material for the heat-insulating layer, zirconium oxide (ZrO₂, zirconia) has become widely accepted, which is almost always partially stabilized with approximately 7 wt. % of yttrium oxide (international abbreviation: “YPSZ” for “Yttria Partially Stabilized Zirconia”). The heat-insulating layers are divided into two basic classes, depending on how they are applied:

thermally sprayed layers (usually by the atmospheric plasma spray (APS) process), in which, depending on the desired layer thickness and stress distribution, a porosity of approximately 10-25 vol. % in the ceramic layer is produced. Binding to the (raw sprayed) bonding layer is accomplished by mechanical interlocking;

layers deposited by the EB-PVD (Electron Beam Plasma Vapor Diffusion) process, which, when certain deposition conditions are observed, have a columnar or a columnar elongation-tolerant structure. The layer is bound chemically by the formation of an Al/Zr-mixed oxide on a layer of pure aluminum oxide, which is formed by the bonding layer during the application process and then during actual operation (Thermally Grown Oxide, TGO). This imposes very strict requirements on the growth of the oxide on the bonding layer.

As bonding layers, either diffusion layers or cladding layers can, in principle, be used.

The list of requirements on the bonding layers is complex and includes the following points which must be taken into account:

low static and cyclic oxidation rates;

formation of the purest possible aluminum oxide layer as TGO (in the case of EB-PVD);

sufficient resistance to high-temperature corrosion;

low ductile-brittle transition temperature;

high creep resistance;

physical properties similar to those of the base material, good chemical compatibility;

good adhesion;

minimal long-term interdiffusion with the base material; and

low cost of deposition in reproducible quality.

For the special requirements in stationary gas turbines, bonding or cladding layers based on MCrAlY (M=Ni, Co) offer the best possibilities for fulfilling the chemical and mechanical conditions. MCrAlY layers contain the intermetallic β-phase NiCoAl as an aluminum reserve in a NiCoCr (“γ”) matrix. The β-phase NiCoAl, however, also has an embrittling effect, so that the Al content which can be realized in practice is ≦12 wt. %. To achieve a further increase in the oxidation resistance, it is possible to coat the MCrAlY layers with an Al diffusion layer. Because of the danger of embrittlement, this is limited in most cases to starting layers with a relatively low aluminum content (Al≦8%).

The structure of an alitized MCrAlY layer consists of the inner, extensively intact γ, β-mixed phase; a diffusion zone, in which the Al content rises to ˜20%; and an outer β-NiAl phase, with an Al content of about 30%. The NiAl phase represents the weak point of the layer system with respect to brittleness and crack sensitivity.

In addition to the oxidation properties and the mechanical properties, the (inter)diffusion phenomena between the base material and the MCrAlY layer—in specific cases also between the MCrAlY layer and the alitized layer—become increasingly more important with respect to service life as the service temperature increases. In the extreme case, the diffusion-based loss of aluminum in the MCrAlY layer can exceed the loss caused by oxide formation. Through asymmetric diffusion, in which the local losses are greater than the supply of fresh material, defects and pores can form and, in the extreme case, the layer can delaminate.

The invention is based on the task of avoiding the disadvantages described above and, in the case of a heat-insulating protective layer of the general type in question, of slowing down the diffusion without negatively influencing the oxidation properties of the alitized layer or the ductility and creep resistance of the layer system.

The task is accomplished according to the invention in the case of a heat-insulating protective layer of the type in question by the characterizing features of Claim 1. Advantageous embodiments of the invention are the objects of Claims 2 and 3.

It has been found that diffusion can be slowed down through the modification of the specially composed NiCoCrAlY bonding layer by the addition preferably of Re but also of W, Si, Hf, and/or Ta in the indicated concentration. The service life of the heat-insulating protective layer, especially of the layer deposited by EB-PVD, is significantly extended by the resistance to diffusion to the base material and to the built-up alitized layer. In the event of the premature failure of the heat-insulating protective layer as a result of, for example, impact by a foreign body or erosion, a relatively long period of “emergency operation” remains possible.

The heat-insulating protective layer is produced in the following way. Onto the base metal of a cooled component in the hot-gas section, such as a blade of a gas turbine, a bonding layer is applied by a process such as thermal spraying. For this purpose, an atomized prealloyed powder with the following chemical composition is used: Co 15-30 wt. %, Cr 15-25 wt. %, Al 6-13 wt. %, Y 0.2-0.7 wt. %, with the remainder consisting of Ni. In addition, the powder also contains one or more of the elements Re up to 5 wt. %, W up to 5 wt. %, Si up to 3 wt. %, Hf up to 3 wt, and Ta up to 5 wt. %. The powder used thus preferably has the following chemical composition: Co 25 wt. %, Cr 21 wt. %, Al 8 wt. %, Y 0.5 wt. %, Re 1.5 wt. %, with the remainder consisting of Ni. After application, the bonding layer has the chemical composition of the powder which was used.

After it has been applied, the bonding layer is coated or the surface is alitized to create an Al diffusion layer to increase the Al content. The coating is accomplished by alitizing the surface, that is, by means of a treatment in which, at elevated temperature, a reactive Al-containing gas, usually an Al halide (AlX₂), brings about an inward-diffusion of Al in association with an outward-diffusion of Ni.

When the surface is alitized in this way, an inner diffusion zone is formed within the diffusion layer on the extensively intact bonding layer, and on top of that an outer built-up layer of a brittle β-NiAl phase is formed. According to a process described in the (as yet unpublished) German Patent Application 10 2004 045 049.8, this outer layer is removed down to the inner diffusion zone of the diffusion layer by blasting it with hard particles such as corundum, silicon carbide, metal wires, or other known grinding or polishing agents. The abrasive treatment is continued until the surface of the remaining diffusion layer has an Al content of more than 18% and less than 30%.

After one of the previously cited processes, the ceramic layer of yttrium oxide-stabilized zirconium oxide is applied as the final step.

1.-3. (canceled)

4. A heat-insulating protective layer for a component which is to be located within a hot-gas section of a gas turbine, comprising:
a bonding layer having a Ni, Co, Cr, Al, Y-containing metal alloy to which one or more chemical-metal elements with a large atomic diameter selected from the group consisting of Re, W, Si, Hf and Ta are added as alloys such that the bonding layer applied to a high temperature-resistant base metal of the component has a chemical composition in accordance with: Co 15-30%, Cr 15-25%, Al 6-13%, Y 0.2-0.7%, Re up to 5%, W up to 5%, Si up to 3%, Hf up to 3%, Ta up to 5%, with a remainder consisting of Ni;
a diffusion layer; and
a ceramic layer, the bonding layer, diffusion layer and ceramic layer being applied to the high temperature-resistant base metal of the component.

5. The heat-insulating protective layer according to claim 4, wherein the Ni, Co, Cr, Al, Y-containing metal alloy is McrAlY, where M=Ni, Co.

6. The heat-insulating protective layer according to claim 4, wherein Re is added as an alloy to the Ni, Co, Cr, Al, Y-containing metal alloy of the bonding layer, so that the bonding layer, after application, has a chemical composition in accordance with: Co 25%, Cr 21%, Al 8%, Y 0.5%, Re 1.5%, with the remainder consisting of Ni.

7. The heat-insulating protective layer according to claim 6, wherein a surface of a MCrAlY layer on the high temperature-resistant base metal is alitized;
the surface-alitized MCrAlY layer has a structure which consists of an inner, extensively intact γ, β-mixed phase, a diffusion layer which consists of an inner diffusion zone with an Al content of about 20%, and an outer built-up layer consisting of a β-NiAl phase with an Al content of about 30%, the outer built-up layer consisting of the β-NiAl phase being removed essentially down to the inner diffusion zone of the diffusion layer by an abrasive treatment; and
wherein the surface of the remaining diffusion layer has an Al content of more than 18% and less than 30%.

8. The heat-insulating protective layer according to claim 4, wherein the diffusion layer is produced by alitization of the bonding layer.

9. The heat-insulating protective layer according to claim 4, wherein the ceramic layer consists of ZrO₂ and is partially stabilized with yttrium oxide.

10. A method for forming a heat-insulating protective layer for a component which to be located within a hot-gas section of a gas turbine, comprising:
applying a bonding layer containing a metal alloy onto a high temperature-resistant base metal of the component for the hot-gas section of the gas turbine;
coating or alitizing a surface of the bonding layer after application to the high temperature-resistant base metal layer to create an Al diffusion layer having an inner diffusion zone and an outer layer;
removing the outer layer of the Al diffusion layer using a grinding or polishing agent; and
applying a ceramic layer to the Al diffusion layer;
wherein one or more chemical-metal elements with a large atomic diameter selected from the group consisting of Re, W, Si, Hf and Ta are added as alloys to material of the bonding layer which, after application to the high temperature-resistant base metal, has a chemical composition in accordance with: Co 15-30%, Cr 15-25%, Al 6-13%, Y 0.2-0.7%, Re up to 5%, W up to 5%, Si up to 3%, Hf up to 3%, Ta up to 5%, with a remainder of the composition consisting of Ni.

11. The method for forming the heat-insulating protective layer of claim 10, wherein said step of coating or alitizing comprises alitizing the surface of the bonding layer.

12. The method for forming the heat-insulating protective layer of claim 12, wherein said step of alitizing comprises treating the surface of the bonding layer with a reactive Al-containing gas at an elevated temperature.

13. The method for forming the heat-insulating protective layer of claim 12, wherein the reactive Al-containing gas comprises an Al halide (AlX₂).

14. The method for forming the heat-insulating protective layer of claim 11, wherein said step of alitizing comprises forming the inner diffusion zone within the diffusion layer on an extensively intact bonding layer, and forming the outer layer on top of the inner diffusion zone.

15. The method for forming the heat-insulating protective layer of claim 14, wherein said outer built-up layer consists of a brittle β-NiAl phase.

16. The method for forming the heat-insulating protective layer of claim 14, wherein said step of removing comprises removing the outer built-up layer down to the inner diffusion zone of the diffusion layer.

17. The method for forming the heat-insulating protective layer of claim 10, wherein the grinding or polishing agent comprises at least one of corundum, silicon carbide and tiny metal wires.

18. The method for forming the heat-insulating protective layer of claim 10, wherein said step of removing comprises grinding or polishing the outer layer until a surface of a remaining diffusion layer has an Al content of more than 18% and less than 30%.

19. The heat-insulating protective layer according to claim 10, wherein the bonding layer comprises a Ni, Co, Cr, Al, Y-containing metal alloy.

20. The heat-insulating protective layer according to claim 10, wherein the ceramic layer consists of ZrO₂ and is partially stabilized with yttrium oxide.
